(19) United States
(12) Patent Application Publication
(10) Pub. No.: US 2025/0079049 A1
(43) Pub. Date: Mar. 6, 2025

(54) DEVICE AND METHOD FOR PRODUCING A CABLE HARNESS

(71) Applicant: Komax Holding AG, Dierikon (CH)

(72) Inventors: Urs Dober, Kussnacht (CH); Adrian Muther, Eschenbach (CH)

(21) Appl. No.: 18/813,103

(22) Filed: Aug. 23, 2024

(30) Foreign Application Priority Data
Aug. 30, 2023 (EP) 23194246.7

(51) Int. Cl. H01B 13/012

(52) U.S. Cl. CPC H01B 13/01245; H01B 13/01209

(57) ABSTRACT

A device for producing a cable harness includes a presentation plate having a front side on which cables of the cable harness can be arranged, and handling elements for handling the cables of the cable harness. The handling elements are magnetically attached to the presentation plate. The device has a pneumatic system that creates an air cushion between the handling elements and the presentation plate formed as a perforated plate. The handling elements each have a front-side handling part and a rear-side moving part positioned on opposite sides of the presentation plate.

### FIELD The invention relates to a device and a method for producing a cable harness.

### BACKGROUND

Cable harnesses such as those used in automobiles or aircraft, for example, consist of a plurality of cables, wherein the cables are each generally provided with plug housings at their prefabricated cable ends. A cable harness is an arrangement of a plurality of cables in which the cables are assembled into a structure with an often complex, branched geometry similar to a tree.

Conventionally, these processing steps are carried out on a laying board by hand or with appropriate electric hand tools. In so doing, the entire cable harness is stretched on the laying board. In particular, workers must remove the nodes of the cable harness from the forked brackets of the laying board in order to work on the areas correctly.

A manually operated laying board is described in U.S. Pat. No. 10,923,250 B2, for example. Cable holding elements can be attached to a presentation plate using suction cups. For handling, this handling element has an elongate handle with which the operator grasps the handling element and accordingly places it at a desired location. The cable holding elements can be inserted via arms that are provided with holes and that are connected to the base part with the suction cup. Furthermore, a presentation plate with slots defined by blind holes has also become known, into which holes the cable holding elements can be directly inserted. The document contains a note stating that instead of suction cups, the handling elements could also be attached magnetically to the presentation plate.

EP 2 672 490 A2 discloses a device of a comparable type with a horizontal presentation plate on which handling elements with U-shaped guide parts, into which the cables can be placed, are magnetically attached. The U-shaped guide part is connected to a base part that is rectangular in plan view and equipped with magnets. Furthermore, a flat friction element is arranged on the base part to prevent slippage. The handling element is difficult to handle and cannot easily be repositioned to another location on the presentation plate. Another problem is that it is only suitable for manual operation.

### SUMMARY

It is therefore an object of the present invention to overcome the disadvantages of what is known, and in particular to create an improved device for producing a cable harness which can be operated efficiently.

According to the invention, this object is achieved by a device having the features described herein. The device for producing a cable harness comprises a presentation plate on which cables of the cable harness can be arranged, and handling elements for handling the cables of the cable harness. When producing a cable harness, it may be necessary that locations and areas of the cable harness have to be secured. For example in so doing, branches and nodes can be secured using suitable tools (for example spot tapes or cable ties). It may also be necessary to provide additional protection for the cable harness as a whole or in regions (e.g. by taping it with adhesive tape). Furthermore, it may be necessary at defined locations to equip the cable harness with mounting elements such as clips in order to be able to ultimately install the cable harness in an apparatus intended for it, such as an automobile. The aforementioned processing of the cable harness is also known to a person skilled in the art as “forming” or “fixing”, since the tree-like structure is created from the plurality of individual cables.

The purpose of the presentation plate is inter alia to present cables or cable harnesses of the cable harness on this plate so that the cables or cable harnesses can be secured or taped manually or mechanically at the designated locations with securing devices such as spot tapes. A handling element is understood below to mean an element with which a single cable or a plurality of cables are handled so that it or they can be processed with a view to producing the cable harness. One such processing is, for example, securing certain points and regions of the cable harness using suitable tools (e.g. spot tapes, cable ties). The presentation plate can be vertically aligned here. Instead of the vertical presentation plate, a horizontal presentation plate or other orientations such as inclined presentation plates would also be conceivable.

The handling elements are magnetically attached or attachable to the presentation plate and are preferably designed such that they can be moved in all directions of the plane defined by the presentation plate. Magnetic attachment has the advantage that it can be reliably secured in position on the presentation plate, and that at the same time, the position of the handling element can be changed quickly and without great effort. Because the device has a pneumatic system with which an air cushion can be created between the handling element and the presentation plate, handling elements can be moved efficiently on the presentation plate.

To create the air cushion between the handling element and the presentation plate, the presentation plate can be designed pneumatically loadable. The presentation plate can be pneumatically loaded actively or passively. In the case of the actively pneumatically loadable presentation plate, the presentation plate can, for example, have evenly distributed and preferably individually controllable air nozzles on its upper side, which blow out air in such a way that an air cushion is created in the region of the handling element. In this case, the pneumatic system is assigned to the presentation plate. However, the pneumatic system can also be assigned to the handling elements (passive loading of the presentation plate).

If required and in particular to move the handling element magnetically attached to the presentation plate, the pneumatic system can be activated by appropriate control, whereupon the advantageous air cushion is formed by means of the pneumatic system between the handling element and the presentation plate.

For certain applications, it may be advantageous if the pneumatic system is designed to increase the adhesion of the handling element to the presentation plate by means of a vacuum if necessary. In this way, the variability and application possibilities can be further increased considerably.

For the pneumatic loading of the presentation plate, the presentation plate can be designed as a perforated plate, which perforated plate has a plurality of holes, preferably distributed in the presentation plate, through which compressed air can be passed to create the air cushion between the handling element and the presentation plate. The holes are therefore preferably designed as through-holes, whereby compressed air can pass from the front of the presentation plate to the back of the presentation plate (and of course vice versa). In this way, two air cushions, i.e., one air cushion in the region of the front-side region and one air cushion on the opposite side (back), can form on the presentation plate after the pneumatic system is activated.

The handling elements can each comprise a front-side handling part and a rear-side moving part, wherein the handling part and the associated moving part are attached to the intermediate presentation plate by means of magnets and preferably by means of permanent magnets in such a way that the handling part can be moved along with the moving part when the latter is moved. During this movement of the handling element on the presentation plate, the air cushion causes the friction between the moving part and the presentation plate on the one hand and between the handling part and the presentation plate on the other to be reduced, which makes the movement easy and, in particular, can be done without a great expenditure of effort. Obviously, the device is designed in such a way that two air cushions or one air cushion with two partial cushion segments per handling element can be created with the pneumatic system itself.

The division of the handling elements into a front-side handling part and a rear-side moving part has significant advantages. Such a two-part handling element with a front-side handling part and a rear-side moving part can be easily and reliably attached to the presentation plate and can be precisely brought into the desired position on the presentation plate. The handling part on the front side with reference to the presentation plate, facing the cable harness, is used for the actual handling of individual parts of the cable harness and comprises means with which cables, for example in the form of cable bundles, prefabricated cable ends equipped with connector housings, branches, etc., can be grasped, held together or otherwise handled. The moving part at the back with reference to the presentation plate is used to move the handling element. In other words, the handling element can be moved manually or mechanically via the moving part. While moving the moving part on the presentation plate, the handling part is moved congruently. Thanks to the division, efficient and trouble-free operation is ensured, as the moving elements required for handling and for movement do not get in the way of each other. Automation of the device is also easily possible thanks to the division. However, intermediate forms are also conceivable, in which the movement is carried out automatically, and at least certain tasks on the cable harness at the front are carried out manually.

For magnetic attachment, the presentation plate designed as a perforated plate can in particular preferably be made of a non-ferromagnetic material. If the handling elements each comprise a front-side handling part and a rear-side moving part, at least one of the parts of the respective handling element can be equipped with a permanent magnet for magnetic attachment to the presentation plate, wherein the other part contains ferromagnetic material, or the other part is also equipped with a permanent magnet so that the permanent magnets attract each other.

Permanent magnets can be used to magnetically attach the handling elements to the preferably vertical presentation plate, with the help of which the handling elements can be held securely in the desired position on the presentation plate. Preferably, permanent magnets (e.g. neodymium magnets) are chosen that are strong enough to prevent the handling elements from accidentally coming loose from the presentation plate, even under a higher load. However, it can also be advantageous if only permanent magnets are selected that are strong enough so that the handling elements can be easily replaced by hand if necessary. The changing process could also be supported by the pneumatic system.

Permanent magnets have the advantage that they ensure reliable operation in a simple manner and remain in the current position on the presentation plate, in particular in the event of a fault (e.g., in the event of an unexpected power failure due to a mains outage).

In a preferred embodiment, the aforementioned vertical presentation plate, on which cables of the cable harness can be arranged on a front side of the presentation plate, can consist of a non-ferromagnetic material. The handling elements or the respective handling elements can each comprise a front-side handling part and a rear-side moving part, wherein at least one of the parts (i.e., handling part, moving part) of the respective handling element is equipped with a permanent magnet for magnetic attachment to the presentation plate, and wherein the other part contains ferromagnetic material, or the other part is also equipped with a permanent magnet but with an unlike pole, so that the permanent magnets attract each other (handling part and moving part therefore roughly correspond to: 1 permanent magnet and 1 ferromagnetic material; or 2 permanent magnets with unlike poles so that the permanent magnets attract each other). The latter case with the two permanent magnets is to be understood as meaning that the permanent magnets are arranged and oriented relative to each other in such a way that unlike poles are opposite each other so that the permanent magnets attract each other.

The respective handling element can have at least one chamber open towards the presentation plate, wherein if a handling part and a moving part are present as described above, preferably the front-side handling part on the one hand and the rear-side moving part on the other hand each have a chamber open towards the presentation plate. Thanks to the chamber, a stable and reliable air cushion can be created so that the handling part can be moved advantageously on the presentation plate. A supporting edge can delimit the respective chamber outward to the side. This supporting edge can run in the direction of the plate and therefore run horizontally in the case of a vertical plate. The supporting edge can preferably be circular.

The moving part can have a coupling part connected to a sliding part. A sliding part is understood to mean a part facing the presentation plate, which part is in contact with the presentation plate and slides along the presentation plate when moved. Thanks to the air cushion, the sliding is almost frictionless. The permanent magnet is preferably integrated in the sliding part. However, the sliding part could also consist of or contain ferromagnetic material. The sliding part can be assigned to the above-mentioned supporting edge, which edge contacts the surface of the presentation plate or is supported or can be supported thereon. The coupling part, on the other hand, is a part facing away from the presentation plate.

The handling part can have a handling head connected to a sliding part. Preferably, the two sliding parts of the moving part on the one hand and of the handling part on the other hand are designed in the same way. The sliding part of the handling part can in particular be designed approximately the same as the main body of the moving part, in particular with regard to its dimensions and in particular with regard to its base area. The permanent magnet is preferably integrated in the sliding part. However, the sliding part could also consist of or contain ferromagnetic material. The above-mentioned supporting edge can be assigned to the sliding part.

The sliding part itself can be constructed in two parts. The two-part sliding part can comprise a front sliding piece with respect to the presentation plate and a main body (as the rear part). The sliding piece and main body can be made of different materials. For example, the sliding piece can be made of plastic, and the main body can be a metal component.

To seal the chamber outwardly, the supporting edge can be designed as a flexible rubber seal. It can be advantageous if a sealing lip made of elastomer is provided or arranged on the supporting edge.

The respective handling element, in particular the moving part of the handling element, can have a pneumatic connection via which compressed air can be fed into the handling element or, if necessary, the vacuum can be created.

The device can have a positioning system for moving the handling elements into the desired position, which positioning system is preferably integrated in the presentation plate, wherein the integrated positioning system is formed in particular by a gantry robot, and the positioning system for moving the handling element comprises a positioning head with a coupling part for mechanical coupling via which the positioning system can be mechanically brought into operative connection with a handling element in each case, and a pneumatic coupling part is integrated in the coupling part by a pneumatic connection, preferably designed as a complementary lance to the pneumatic connection of the handling element. Using gantry robots, the handling elements can be moved quickly and precisely into the desired position, wherein, depending on requirements, even complicated paths can be easily covered when moving using the gantry robot. As an alternative to the gantry robot, delta robots or other types of positioning robots or positioning systems are also conceivable.

In order to move a plurality of handling elements, the positioning system can comprise a positioning head with a plurality of coupling parts via which the positioning system can be mechanically brought into operative connection (i.e., coupled) with one or more handling elements so that the movement of the positioning head can then be transferred to the handling element. The coupling parts can be movable relative to each other separately or together, at least with respect to the plane of the presentation plate. These multiple coupling parts can be rigidly connected to each other. However, it can be advantageous if the multiple coupling parts can be moved separately relative to each other at least in relation to the plane of the presentation plate, which enables even more complex movements.

In a preferred embodiment, the moving part of the handling element can be a coupling part with a spherical outer contour for the mechanical coupling, wherein the outer contour has a flattening of the spherical shape. In this case, an insertion opening sealed or sealable by means of an O-ring, into which, for example, the lance is inserted or can be inserted, can be arranged within the coupling part for the pneumatic coupling to create the pneumatic connection.

A further embodiment relates to a device in which at least some of the handling elements are designed as housing holders for holding housings. The respective housing holder can temporarily hold a single or, in some cases, even several housings for the production of the cable harness. A housing, the purpose of which is to create electrical plug-in connections in particular, or more precisely the prefabricated cable end provided with the housing, can be moved into the desired position on the presentation plate thanks to the housing holder. The housing holder can comprise a housing receptacle into which the housing(s) can be inserted for secure holding, or other means for temporarily holding the housing. The housing receptacle is assigned to the handling head of the housing holder.

Alternatively or additionally, at least some of the handling elements can be designed as deflectors for deflecting the course of cables. If the housing holders are seen as the first type of handling elements, the deflectors for deflecting the course of cables of the cable harness (one or, if necessary, a plurality of cables can be deflected, wherein in the case of a plurality of cables the cables are usually present as a loose or already secured cable bundle) form a second type of handling elements. For example, deflectors are usually used to bend individual cables at defined positions, for example at branches, in the branched structure of the cable harness.

Alternatively or additionally, at least some of the handling elements can be designed as hold-up means. The hold-up means form a third type of handling elements. Hold-up means are used to hold up individual cables or a plurality of cables combined in the form of a cable harness and thus increase the distance to the presentation plate in order to enable cables to be passed under the aforementioned individual cable or cables held up. By means of one and preferably two hold-up means, for example, a main strand of the cable harness can be held in a portion further away from the positioning plate, whereby an enlarged gap arises below the cable harness held up in this way so that other parts of the cable harness can be guided underneath without obstruction, for example by means of a housing holder, thereby enabling further branching on two sides.

A further aspect of the invention relates to a device for producing a cable harness, in particular the device described above, which is characterized in that a handling part attached or attachable to a presentation plate has a handling head adjoining a sliding part, which handling head is preferably rotatably connected to the sliding part with respect to a normal direction predetermined by the presentation plate, wherein the bearing for the rotatable connection between the handling head and the sliding part has a locking mechanism for securing the handling head in a desired rotational position (secured position). The normal direction is understood here to be a direction running at right angles to the plane of the presentation plate. The rotation axis of the handling head, which is rotatably connected to the sliding part in the normal direction, can therefore be a horizontal rotation axis in the case of a vertical presentation plate.

Preferably, the locking mechanism is in operative connection to the pneumatic system for creating the air cushion between the handling element and the presentation plate so that, by means of the pneumatic system, after appropriate control of the pneumatic system, the rotation lock by the locking mechanism can be canceled, and the handling head is connected to the sliding part in a freely rotatable manner.

The device can then comprise a processing robot, with the aid of which securing means can be attached to the cables for fixing and securing them point by point or section by section. This processing robot, designed for example as an articulated arm robot, can be arranged in the region of a rear side of the presentation plate, wherein in contrast to the preferred positioning system, the processing robot is usually separate. It can be firmly connected to the ground or designed to move autonomously on the ground.

In terms of the method, the invention is characterized in that (i) cables equipped with housings and required for the cable harness are arranged on a presentation plate using housing holders and other handling elements, wherein the handling elements are magnetically attached to the presentation plate, and in that (ii) the handling elements are moved on the presentation plate by introducing compressed air into the handling element or elements to be moved by means of a pneumatic system, whereby an air cushion is created between the handling element and the presentation plate. This method for producing a cable harness can be carried out in particular using the above-described device.

If the handling elements each comprise a front-side handling part and a rear-side moving part, the respective handling element can be magnetically attached to the presentation plate in that the handling part and the moving part attract each other and thus adhere together to the presentation plate. When magnetically attaching, the intermediate presentation plate is, to a certain extent, clamped between the handling part and the associated moving part by means of or under the effect of the magnetic force. In other words, the attractive forces of the magnets assigned to the handling part on the one hand and the moving part on the other hand cause the presentation plate in between to be clamped.

At least one of the parts of the respective handling element can be equipped with a permanent magnet for magnetic attachment to the presentation plate, wherein the other part contains ferromagnetic material, or the other part is also equipped with a permanent magnet so that the permanent magnets attract each other.

The handling elements can be moved in individual steps. It can be advantageous if, after completion of a single-step movement of the handling element, the compressed air supply is first disconnected from the handling element and then, i.e., after separation, the mechanical coupling of the handling element to a positioning system for moving the handling element into the desired position is canceled. The two steps of separating the compressed air supply and canceling the mechanical coupling can be carried out very quickly one after the other.

If the handling element must be held on the presentation plate with increased adhesion, a vacuum can be created between the handling element and the presentation plate. The handling element can thus be temporarily fixed securely and practically immovably on the presentation plate.

### DESCRIPTION OF THE DRAWINGS

Further individual features and advantages of the invention can be derived from the following description of exemplary embodiments and from the drawings. In the drawings:

FIG. 1 shows a perspective view of a device according to the invention for producing a cable harness with a presentation plate, and a plurality of handling elements mounted thereon (presentation plate seen from the front),

FIG. 2 shows the device from FIG. 1 in a perspective view from a different viewing direction (presentation plate seen from the back),

FIG. 3 shows a perspective, enlarged view of the presentation plate and three types of handling elements (housing holder, deflector, hold-up means) for the device according to FIG. 1,

FIG. 4 shows a perspective view of a positioning head with a plurality of coupling parts for moving handling elements, and a handling element designed as a housing holder,

FIG. 5a shows a plan view of a presentation plate with a moving part of a handling element lying thereon,

FIG. 5b shows the presentation plate in an alternative design,

FIG. 6 shows a side view with a broken view of a handling element of the device according to the invention designed as a housing holder and attached to the presentation plate,

FIG. 7 shows the handling element from FIG. 6 with the coupling part of the positioning system coupled thereto at a slight angle,

FIG. 8 shows the handling element with the just-coupled coupling part of the positioning system, wherein the handling element is in a position in which the rotational locking of its handling head to a sliding part, caused by a locking mechanism, is canceled,

FIG. 9 shows a perspective, enlarged view of the presentation plate and the handling element designed as a housing holder with the handling head rotatably connected to the sliding part, and

FIG. 10 shows a plan view of components of an alternative presentation plate for the device according to the invention for producing a cable harness.

### DETAILED DESCRIPTION

FIG. 1 shows a device 1 for producing a cable harness. Cable harnesses such as those used in automobiles or aircraft, for example, consist of a plurality of cables, wherein the cables are each generally provided with plug housings at their prefabricated cable ends. A cable harness is an arrangement of a plurality of cables or lines in which these are assembled into a structure with an often complex, branched geometry similar to a tree. The respective cable is usually an electrical cable containing, for example, a solid conductor made of copper or aluminum or stranded wire and insulation as a sheath for the conductors. The term “cable” is to be understood broadly below. In this context, a cable is also understood to mean, for example, a cable unit consisting of a plurality of cables or lines of equal length combined into a unit, such as a twisted cable harness.

In addition to the device 1 shown in FIG. 1, the system can further comprise a cable processing machine and a housing assembly machine (not shown here), which can be located upstream of the device 1. The cable processing machine can comprise a stripping station, known per se, for cutting and stripping the cable, one or more crimping stations for applying crimp contacts to the stripped cable ends and, where necessary, one or more grommet stations. In the housing assembly machine, connector housings are assembled with prefabricated cable ends of the cables from the cable processing machine.

After wiring, cable harnesses must be prepared for their intended use so that they can then be installed in the intended apparatuses, such as automobiles. The cables required for the respective cable harness, which were assembled for example in the aforementioned cable processing machine and housing assembly machine, are assembled into a tree-like structure by means of the device 1 described in detail below. In so doing, branches and nodes must be secured using suitable securing means (e.g. spot tapes or cable ties). The cable harness may need to be provided with additional protection, either completely or in regions (e.g. by taping with resistant adhesive tape).

The device 1 for producing a cable harness comprises a vertical presentation plate 2 on which cables of the cable harness can be arranged on a front side of the presentation plate 2. The cables designated by 4, which are already assembled and equipped with housings, are arranged in an intermediate position shown in FIG. 1 in the form of more or less freely hanging loops on the presentation plate 2. The housings of the cables 4 are held by housing holders 5. In FIG. 1, two further types of handling elements can be seen, namely deflectors marked 5′ and hold-up means marked with 5″. These handling elements are located in a waiting position in parking zones at the edge of the presentation plate 2. These handling elements wait until they are used, if necessary, to produce a cable harness.

The device 1 further comprises a processing robot 40 in the region of the front side of the presentation plate 2, with the aid of which securing means can be attached to the cables 4 for fixing and securing them point by point or section by section. With the processing robot 40, for example, spot tapes can be applied. The processing robot 40 is designed as an articulated arm robot in the present case. The articulated arm robot 40 can be firmly connected to the floor or designed to move autonomously on the floor.

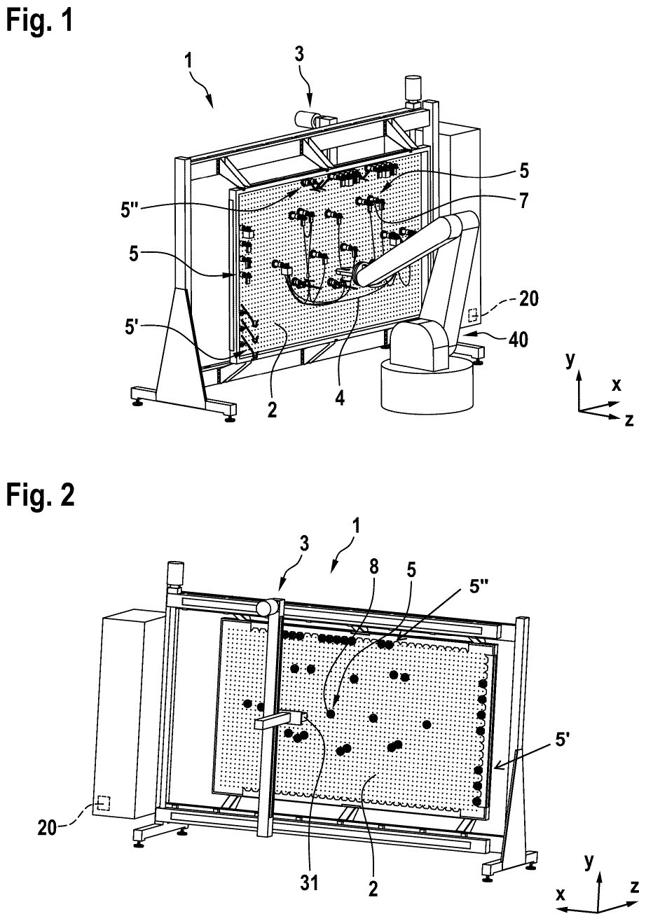

As can be seen from the rear view of the presentation plate 2 according to FIG. 2, the handling elements 5, 5′, 5″ can be moved by means of a gantry robot positioning system 3 on the presentation plate in all directions of the plane defined by the presentation plate 2.

The presentation plate 2 is preferably made of a non-ferromagnetic material. The presentation plate 2 can, for example, be made of a stainless steel. But other metal plates made of non-ferromagnetic material can also be used for the presentation plate. The presentation plate 2 could also be made of plastic.

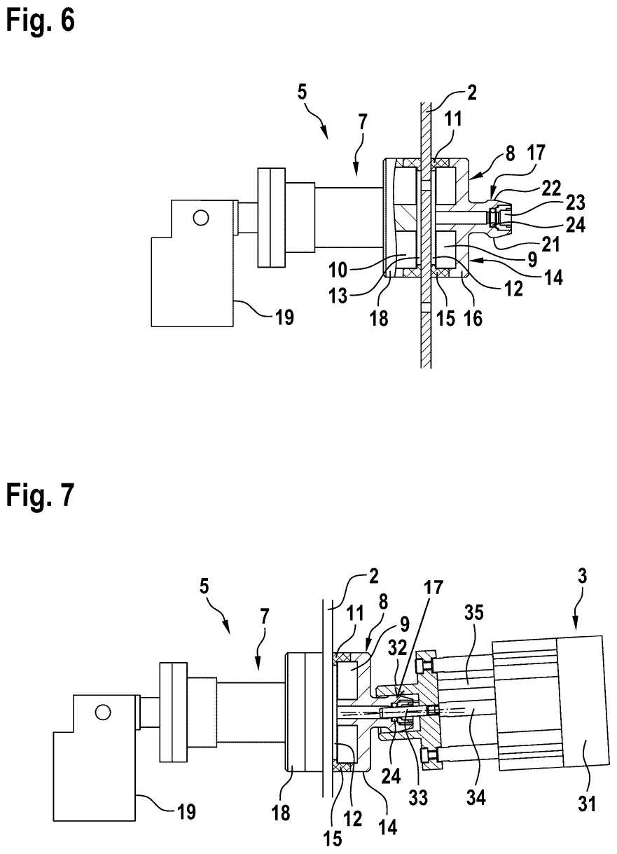

Each of the handling elements 5, 5′, 5″ comprises a front-side handling part 7 and a rear-side moving part 8 (see FIG. 2), wherein the handling part 7 and the moving part 8 are each equipped with a permanent magnet for magnetic attachment to the presentation plate 2 so that the permanent magnets attract each other. For this purpose, the permanent magnets are arranged and oriented relative to each other in such a way that unlike poles are opposite each other, whereby the permanent magnets attract each other (see FIG. 6). When the moving part is moved on the presentation plate, the handling part is entrained. One permanent magnet can be provided for each part (handling part, moving part); however, a plurality of permanent magnets could also be provided and be advantageous for each part.

The attractive forces of the magnets cause a clamping of the intermediate presentation plate 2. The handling elements 5, 5′, 5″ thus remain in their position on the vertically aligned presentation plate 2.

In order to temporarily reduce the static friction of the handling elements 5, 5′, 5″ on both sides of the presentation plate 2, the presentation plate 2 is provided with a hole pattern, and the positioning system 3 is equipped with a compressed air supply. For this purpose, the device 1 has a pneumatic system with which an air cushion can be created between the handling element 5, 5′, 5″ and the presentation plate 2. The two parts of the handling elements 5, 5′, 5″ (coupling part and handling part) have one chamber each to build up an air cushion.

Thanks to the air cushion, the strong adhesive forces resulting from the permanent magnets can be reduced, whereby the handling elements 5, 5′, 5″ can be moved easily and effortlessly on the presentation plate 2. In the figures, a compressor 20 of the pneumatic system is shown as a source of compressed air for operating the pneumatic system. The compressed air source in the present case is integrated in the device 1. The compressed air source, for example the compressor or another compressed air source for providing the compressed air could of course also be arranged externally. Furthermore, a compressed air supply line is conceivable to provide the compressed air.

Since, especially with larger cable harnesses, the clamping force of the magnets must be sufficiently large so that the handling elements 5, 5′, 5″ can be able to hold their position despite the additional weight on the presentation plate 2, the magnets are designed correspondingly strong.

Thanks to the pneumatic system, comparatively simple positioning systems can be used that do not have to be designed particularly powerful or robust, since the air cushion means that the high static friction created by clamping with the magnets no longer has to be overcome.

FIG. 2 shows the device 1 with a rear view of the presentation plate 2. Here, the moving parts are visible and marked by 8. In the present case, the moving parts 8 for all types of the handling elements 5, 5′, 5″ are designed substantially identical.

The moving parts 8 are responsible for the movement of the handling elements 5, 5′, 5″. To move the handling elements into the desired position, the device 1 has a positioning system 3. The positioning system 3 integrated in the presentation plate 2 is in the present case formed by a gantry robot. The positioning system 3 or the gantry robot has a beam-like gantry carriage that can be moved back and forth in the x-direction along linear guides, and a second carriage that can be moved back and forth in the y-direction transversely to the x-direction along the gantry carriage and is equipped with a positioning head 31. The positioning head 31 of the gantry robot forms, so to speak, the interface to the handling element. The positioning head 31 can grasp the handling element via coupling means and bring it to the desired location through the controlled movement of the gantry robot. For this purpose, the positioning head 31 has at least one coupling part which can be brought into engagement with a coupling part of the handling element for the movement.

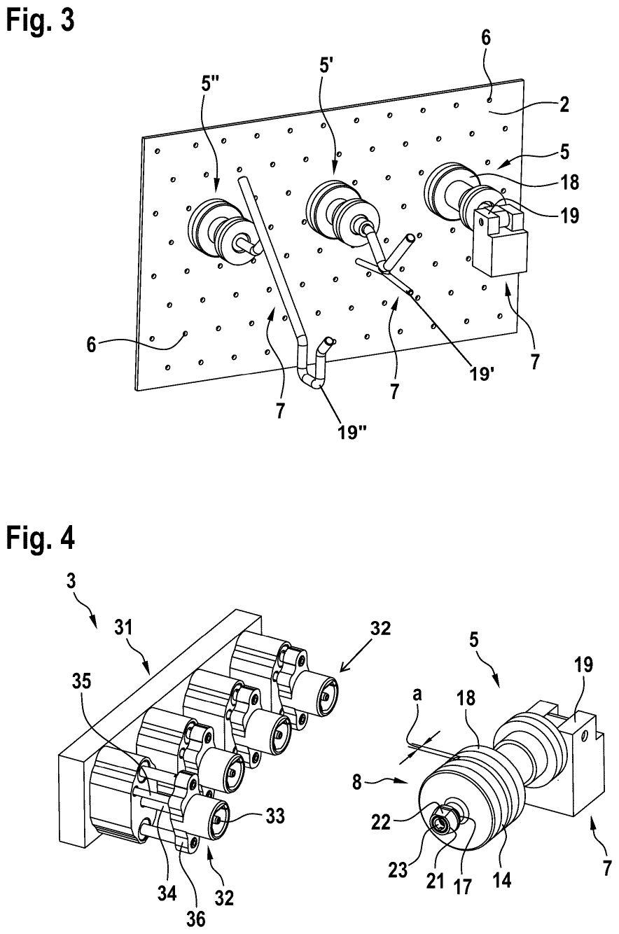

FIG. 3 shows the three different types of handling elements: housing holder 5, deflector 5′ and hold-up means 5″. The handling elements differ substantially in the different design of the front-side handling part 7; the rear-side moving parts 8 are of approximately the same design for all handling elements. The handling part 7 of the housing holder 5 has a handling head 19 which is rotatably connected to a sliding part 18. The housing holder 5 has means for temporarily holding the housing, for example in the present case a housing receptacle into which the housing can be inserted for secure holding. The handling part 7 of the deflector 5′ and the hold-up means 5″ have sliding parts which are designed to be similar to the sliding part 18 of the housing holder 5, at least with regard to external shape and dimensions. The difference lies mainly in the different design of the respective handling heads. The handling part of the deflector 5′ clearly has a handling head 19′ with a hook. The handling part of the hold-up means 5″ has a handling head 19″ with a U-shaped cable receiving portion in which cables are collected and held loosely together, wherein the cable receiving portion for holding up is further away from the presentation plate 2.

The handling part of the deflector 5′ can have a handling head connected to a sliding part 18, which is fixedly or preferably freely rotatably connected to the sliding part. When the deflector is attached to the presentation plate 2, the axis of rotation runs with respect to the normal direction (z-direction) defined by the presentation plate 2. The handling head 19′ of the deflector 5′ is designed such that when the deflector 5′ is mounted on the presentation plate 2, it remains in its vertically aligned basic position due to gravity. The same also applies to the hold-up means 5″. The hold-up means 5″ also has a handling head 19″ which is connected to a sliding part and is freely rotatably connected to the sliding part 18. The handling head 19″ of the hold-up means 5″ is designed such that when the hold-up means 5″ is mounted on the presentation plate 2, it remains in its vertically aligned basic position due to gravity.

The handling elements 5, 5′, 5″ are mounted on a presentation plate 2 designed as a perforated plate and made of a non-ferromagnetic material, which perforated plate has a plurality of through-holes 6 evenly distributed in the presentation plate, through which holes 6 compressed air can be passed to create the air cushion between the handling element 5, 5′, 5″ and the presentation plate 2.

The operation of the pneumatic system of the device 1 is explained below on the basis of FIGS. 4 to 8. FIG. 4 relates to a perspective view of a positioning head 31 with a plurality of coupling parts for moving handling elements, and a handling element 5 designed as a housing holder, wherein the handling element 5 is aligned in such a way that its coupling part 17 is more clearly visible for a better understanding of the interface.

The positioning head 31 assigned to the gantry robot of the positioning system 3 has a plurality of coupling parts 32. In the present case, the positioning head 31 has, for example, four coupling parts 32 aligned horizontally. Four handling elements could be moved simultaneously via the coupling parts 32. In FIG. 4, the closest coupling part 32 from the viewpoint of the observer is in an extended position in which coupling would be possible. The remaining three coupling parts are in a rest position. In this position, only one handling element could be moved with the positioning system 3. However if required, additional or other coupling parts could be extended to create an active position, whereupon two or more handling elements can be moved. Of course, it is conceivable to equip the positioning head 31 of the positioning system 3 only with one such a coupling part 32.

The respective coupling part 32 is designed like a socket for the mechanical coupling. A pneumatic coupling part designed as a lance 33 is integrated in the coupling part. The lance 33 is clearly arranged centrally in the cavity of the coupling part 32.

The coupling parts 32 are mounted so as to be movable to a limited extent relative to the positioning head 31 in the normal direction defined by the presentation plate 2. 35 designates a compressed air supply line of the pneumatic system, which supplies compressed air to the lance 33. 34 designates a pneumatic actuator with the aid of which the coupling part 32 can be extended from the rest position into the active position. The coupling parts can be preloaded in the rest position, for example by means of springs (not shown).

Each of the coupling parts 32, which can be extended by means of pneumatic actuators 34, has plate-like segments 36, in each of which segments 36 a sealed transverse bore (not shown) is arranged in order to conduct compressed air from the compressed air supply line 35 to the lance 33. The compressed air supply line 35 is a rigid tube with a seal in order to be able to follow the movement when extending and retracting. The actuator 34 comprises a piston rod running coaxially to the lance 33.

The handling element 5 consists, as can be seen from FIG. 4, of the front-side handling part 7 and the rear-side moving part 8. The presentation plate 2 is not shown in FIG. 4. However, “a” indicates a distance or space between the front-side handling part 7 and the rear-side moving part 8, which distance corresponds to the thickness of the presentation plate 2. The presentation plate, not shown here, is contacted by sliding parts 14, 18 of the handling part 7. The sliding part 14 is part of the coupling part 17 of the handling element 5 and is thus assigned to the moving part 8; the sliding part 18 is assigned to the handling part 7.

The coupling part 17 of the handling element 5 has a spherical outer contour 21 for the mechanical coupling, wherein it has a flattening 22 of the spherical shape. The spherical shape is for being able to compensate for slight angular errors between the presentation plate and the positioning system. The flattening serves to prevent the handling element from rotating when moved on the presentation plate.

If a specific handling element is to be moved, the positioning head 31 is moved towards the handling element by means of the gantry robot, and then the coupling part 32 is extended. Upon extending the coupling part 32, the coupling part 32 comes into contact with the coupling part 17 assigned to the handling element. The coupling process is now complete, and the handling element may now be moved. However, before the onset of the movement, the pneumatic system is activated, and compressed air is fed into the handling element. An air cushion forms between the handling element and the presentation plate; the handling element can now be moved practically frictionlessly on the presentation plate.

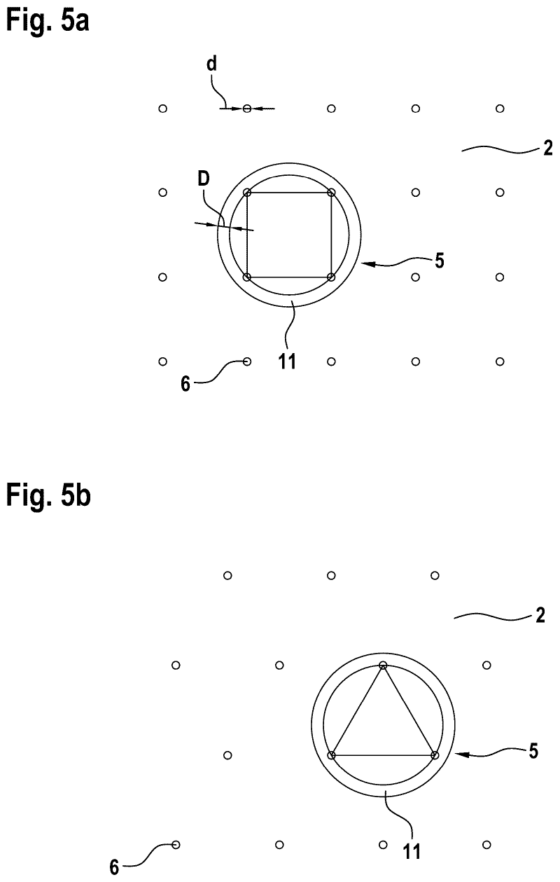

FIG. 5a shows a hole pattern of the presentation plate 2. The holes 6 form a kind of perforated sieve structure and are arranged at equal intervals in a straight grid distributed on the presentation plate 2. In FIG. 5a, 11 further indicates a supporting edge of a sliding piece of the handling element 5. This sliding piece can be assigned to either the handling part 7 or the moving part 8, since the respective sliding pieces of both elements (handling element, moving part) are substantially identical in design.

FIG. 5b shows a variant for a hole pattern of the presentation plate 2. In this hole pattern, the 6 holes are arranged alternately offset to each other in rows, which forms a triangle pattern indicated by lines connecting three of the holes 6.

The hole pattern can be square (indicated by lines connecting four of the holes 6 in FIG. 5a) or triangular (FIG. 5b). In this regard in the preferred embodiments, a hole 6 must always be located within the air chamber region of the handling element or, in other words, at least the added area of a hole 6 must always be within the chamber region in order to ensure a continuous travel plane during the movement of the handling element on the presentation plate.

Furthermore, the sizes of the holes, which are for example round in the present case, are advantageously selected such that the hole diameter d is smaller than the thickness D of the supporting edge 11 of the handling elements.

Design details for the structure of the handling element 5 can be seen in FIGS. 6 and 7. A housing holder is shown here. The structure of other handling elements such as deflectors and hold-down devices is basically the same except for the handling heads. FIG. 6 shows a handling element 5 magnetically attached to the presentation plate 2 and designed as a housing holder, for example. In the handling part 7 on the one hand and in the moving part 8 on the other hand of the handling element 5, one or more permanent magnets are inserted, which are designated here by 9 and 10. The relevant parts each have corresponding receptacles in the sliding parts 14, 18, into which the permanent magnets 9, 10 are inserted. The sliding parts are constructed identically and substantially differ only in the polarity of the magnets used therein. The sliding part 14, 18 itself is constructed in two parts and consists of a front sliding piece 15 with respect to the presentation plate 2 and a main body 16 as the rear part. The sliding piece 15 is preferably made of plastic, and the main body 16 of metal. The handling part 7 of the handling element 5 has a chamber 13 open towards the presentation plate 2; the moving part 8 on the other hand has a chamber 12 open towards the presentation plate 2. The supporting edge 11 delimits the respective chamber 12, 13 outward to the side.

The moving part 8 has a pneumatic connection via which the compressed air can be fed into the handling element 5. For this purpose, an insertion opening 23 which can be sealed by means of an O-ring 24 and into which the lance (not shown here) can be inserted is arranged within the coupling part 17.

In FIG. 7, in which the broken view is slightly adapted compared to FIG. 6, it is shown that, after coupling, the coupling part 32 assigned to the positioning system 3 could still be connected to the coupling part 17 even in a slightly inclined position due to the inherently undesirable inaccurate positioning of the positioning head 31. The mechanical coupling of the handling element 5 is designed spherical with a flattening in order to compensate for slight angular errors between the presentation plate 2 and the positioning system 3. In the normal or longitudinal direction of the lance 33, sufficient clearance is provided before and after the O-ring 24 in order to be able to compensate, here as well, for the angular errors between the presentation plate and the positioning system. Therefore, the compressed air coupling and the mechanical coupling are preferably matched to each other so that the center of the sphere 21 (FIG. 6) and the sealing O-ring 24 are at the same height.

The handling element 5 is thus equipped with a compressed air coupling in order to be able to take in the compressed air, to direct it to the first chamber 12, through the presentation plate 2 and to the second chamber 13.

A further advantage of the device 1 is that, if required, when the handling element 5 is to be held with increased adhesion on the presentation plate 2, a vacuum is created between the handling element 5 and the presentation plate 2. Thus, the pneumatic system can operate the handling element 5 in two different states: in a state in which compressed air creates the air cushion for the movement, and a state in which the vacuum holds the handling element to the presentation plate with a particularly high holding force.

Thanks to this embodiment, a vacuum can also be temporarily created in the chambers 12, 13 via the positioning system 3. The vacuum increases the absorbable forces of the handling elements 5, which makes the processing of the cable branches of the cable harness less sensitive. The vacuum can either be provided via a compressed air supply line or created using a Venturi nozzle.

The handling elements 5 can be moved in individual steps. After the displacement step, the positioning system 3 first disconnects the compressed air supply and then the mechanical connection to the handling element. Otherwise, an undesirable sagging of the handling element 5 attached to the vertical presentation plate 2 may occur. The two steps of separating the compressed air supply and canceling the mechanical coupling can be carried out very quickly one after the other.

As previously described, compressed air can be fed from the compressed air supply line 35 to the lance 33 via a transverse bore in the plate-like segment 36. However, other designs are also conceivable, such as a design without the separate line 35. For example, the compressed air for extending the coupling part 32 can flow through a taper in the form of an orifice through the piston rod 28 of the pneumatic actuator 34 into the lance 33 and further into the handling element 5, where the air cushion is built up. Once the target position has been reached, the compressed air can be switched so that no new air is fed through the piston rod, which causes the air cushion to collapse. To do this, the piston rod is pushed back with the redirected air. Since the coupling and the lance allow a certain stroke without loss of contact, the handling part is still guided for a short time of the backward movement.

According to a further embodiment, sealing lips of elastomer (not shown) can be installed around the chambers to make either the air cushion or, if necessary, a vacuum more efficient. These sealing lips could be formed on the sliding piece 15 in the region of the supporting edge 11 or attached thereto.

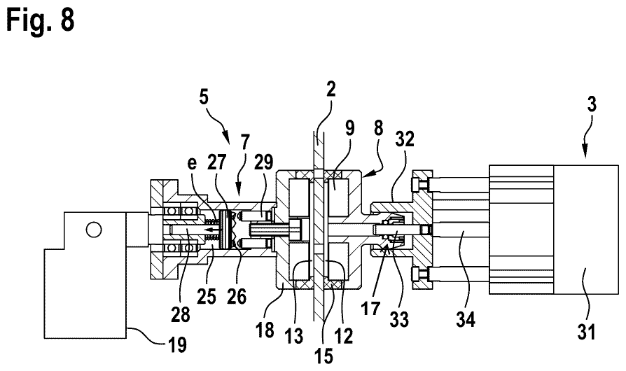

FIG. 8, in which the broken view is again adapted compared to FIGS. 6 and 7, shows a variant of a handling element 5 in which the bearing between the sliding part 18 and the handling head 19 has a special rotation lock. Here—in comparison to FIG. 7—the coupling part 32 assigned to the positioning system 3 is connected to the coupling part 17 of the handling element 5 in the normal coupling position that usually occurs.

When presenting the branches of the cable harness, situations may arise in which the cable branch and the handling head 19 of the handling element 5 are only aligned with each other under great pulling force (e.g. horizontal alignment). If further tensile forces are applied during processing of the branches (e.g. bandaging), the handling element 5 must be designed sufficiently large in order to be able to absorb all forces. Therefore, in the embodiment shown in FIG. 8, the handling element 5, which is designed in particular as a housing holder, is supplemented with a locking mechanism which can be decoupled by means of the supplied compressed air.

The handling element 5, designed as a housing holder and mounted on the presentation plate 2, has a handling head 19 connected to a sliding part 18, and is rotatably connected to the sliding part 18 with respect to the normal direction, wherein the bearing for the rotatable connection between the handling head 19 and the sliding part 18 has a locking mechanism 25 for securing the handling head in a desired rotational position (secured position). The locking mechanism is operatively connected to the pneumatic system so that by means of the pneumatic system, after appropriate control, the rotation lock created by the locking mechanism 25 can be canceled, and the handling head 19 is freely rotatably connected to the sliding part 18.

The locking mechanism 25 serves to determine the orientation of the handling head 19. By means of the supplied compressed air, the locking mechanism 25 is levered out so that the handling head 19 can rotate freely according to the tensile forces of the cable branch. The locking mechanism 25 can, for example, have a pitch of 45° or more (90°, 120° or) 180°.

The locking mechanism 25 comprises a locking crown 26 arranged at the end of a piston 27, into which locking cams 29 assigned to the handling head 19 engage or can engage in a locking manner. Furthermore, a piston rod 28 with, for example, a square cross-section can be seen. In order to release the rotation lock by the locking connection, compressed air is fed into the piston chamber after appropriate control, and the spring-loaded piston 27 is displaced in the “e” direction, whereby the locking crown 26 is removed from the locking cams 29 to such an extent that the locking connection is canceled, and the free rotation of the handling head 19 accordingly results. FIG. 8 shows the locking mechanism in such a position in which it is disengaged.

Thanks to this locking mechanism 25, the handling head 19 can be pulled into the desired angular position and held, although the tension on the branch of the cable harness has been reduced. This has the further advantage that the handling elements 5 can be made smaller.

The decoupling of the locking mechanism 25 can take place either together with the construction of the air cushion with a common operating pressure or independently thereof (by means of two operating pressures).

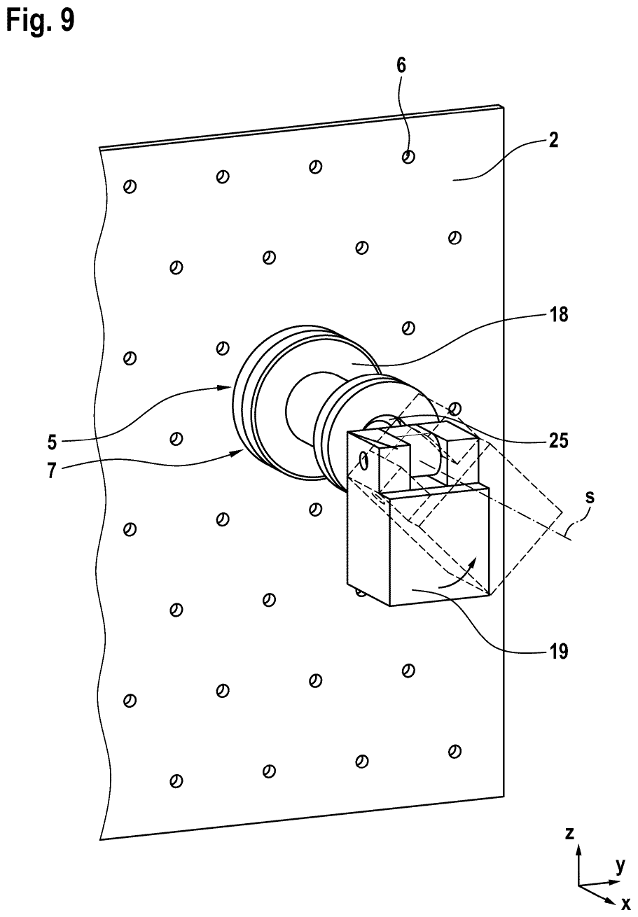

FIG. 9 shows the handling element 5 designed as a cable housing holder with the handling head 19 rotatably connected to the sliding part 18. The handling head 19 can be rotated from the shown vertically aligned basic position by 45° about the rotation axis designated by S. Thanks to the locking mechanism 25, the handling head 19 can be pulled into the desired angular position and held in the angular position indicated by dashed lines.

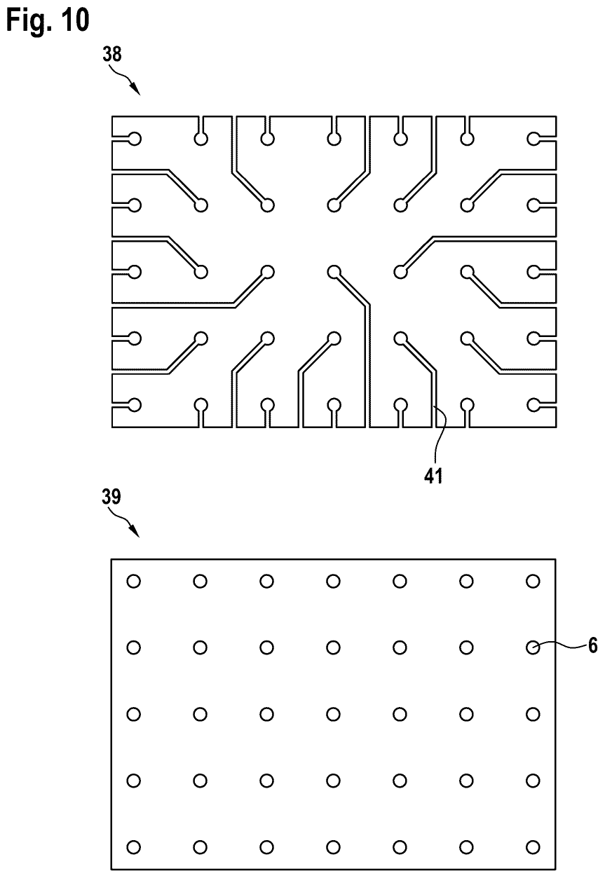

The presentation plate 2 shown in FIG. 3, and designed as a simple perforated plate, is passively pneumatically loaded. The pneumatic system is assigned to the handling elements 5. However, designs of presentation plates that are actively pneumatically loaded are also conceivable. Such an actively pneumatically loadable presentation plate, or its main components, is shown in FIG. 10. 39 designates an outer plate designed as a perforated plate. 38 designates an intermediate plate. The presentation plate is a composite component with two outer plates 39 and an intermediate plate 38 arranged between them. The plates 38, 39 can be connected to each other, for example by gluing them together. The intermediate plate 38 has channel-like recesses 41 which extend from the edge to ends which, after assembly, lead to the holes 6. In this way, the individual holes 6 could be supplied with compressed air from the edge, for example controlled via valves (not shown). An alternative actively pneumatically loadable presentation plate can, for example, have evenly distributed and preferably individually controllable air nozzles on its upper side, which blow out air in such a way that an air cushion is created in the region of the handling element.

In accordance with the provisions of the patent statutes, the present invention has been described in what is considered to represent its preferred embodiment. However, it should be noted that the invention can be practiced otherwise than as specifically illustrated and described without departing from its spirit or scope.

1. A device for producing a cable harness, the device comprising:
a presentation plate having a front side adapted for arranging cables of the cable harness;
a handling element adapted to handle the cables, the handling element being magnetically attached to the presentation plate; and
a pneumatic system selectively creating an air cushion between the handling element and the presentation plate.

2. The device according to claim 1 wherein the presentation plate is pneumatically loadable.

3. The device according to claim 1 wherein the pneumatic system selectively increases adhesion of the handling element to the presentation plate by creating a vacuum between the handling element and the presentation plate.

4. The device according to claim 1 wherein the handling element includes a front-side handling part and a rear-side moving part.

5. The device according to claim 4 wherein the presentation plate is a perforated plate having a plurality of holes formed therein through which compressed air can pass, the handling part being positioned on the front side of the presentation plate and the moving part being positioned on a rear side of the presentation plate.

6. The device according to claim 5 wherein the handling part and the moving part each have a chamber open towards the presentation plate.

7. The device according to claim 6 wherein each of the chambers has a supporting edge sealing the respective chamber against the presentation plate.

8. The device according to claim 1 wherein the handling element has a pneumatic connection via which compressed air can be received from the pneumatic system.

9. The device according to claim 1 including a positioning system adapted to move the handling element into a desired position on the presentation plate, wherein the positioning system includes a positioning head with a coupling part that mechanically couples to the handling element and a pneumatic coupling part integrated in the coupling part.

10. The device according to claim 9 wherein the pneumatic coupling part is a lance.

11. The device according to claim 1 wherein the handling element has a moving part with a coupling part, wherein the coupling part has a spherical outer contour that includes a flattening, and the coupling part has an insertion opening with an O-ring seal that is arranged inside the coupling part.

12. The device according to claim 1 wherein the handling element has a handling part releasably attached to the presentation plate, the handling part having a handling head rotatably connected to a sliding part, a locking mechanism securing the handling head in a desired rotational position relative to the sliding part.

13. The device according to claim 12 wherein the locking mechanism is operatively connected to the pneumatic system such that the pneumatic system can cancel the securing of the handling head whereby the handling head can be freely rotated relative to the sliding part.

14. A method for producing a cable harness, the method comprising using the device according to claim 1 to perform the steps of:
arranging cables fitted with housings on the presentation plate using a plurality of the handling element magnetically mounted on the presentation plate; and
moving the handling elements on the presentation plate by introducing compressed air from the pneumatic system, whereby an air cushion is created between the handling elements and the presentation plate.

15. The method according to claim 14 wherein the device includes a positioning system mechanically coupling to one of the handling elements, and including after completion of a single-step movement of the one of the handling elements, first disconnecting the compressed air from the one handling element, and then disconnecting the mechanical coupling of the one handling element.

16. The method according to claim 14 including operating the pneumatic system to create a vacuum between one of the handling elements and the presentation plate to increase adhesion of the one handling element on the presentation plate.
